(19) United States
(12) Patent Application Publication
(10) Pub. No.: US 2018/0005123 A1
(43) Pub. Date: Jan. 4, 2018

(54) COMBINING SEMANTIC AND BUSINESS PROCESS MODELING IN A MULTI-LAYER FRAMEWORK

(71) Applicant: Xerox Corporation, Norwalk, CT (US)

(72) Inventors: Nikolaos Lagos, Grenoble (FR); Jean-Yves Vion-Dury, Biviers (FR); Adrian Corneliu Mos, Meylan (FR)

(73) Assignee: Xerox Corporation, Norwalk, CT (US)

(21) Appl. No.: 15/200,665

(22) Filed: Jul. 1, 2016

(51) Int. Cl. G06N 5/04

(52) U.S. Cl. CPC G06N 5/04

(57) ABSTRACT

A method for semantic representation supporting multiple formalisms includes providing a business modeling space (BMS) and a corresponding semantic modeling space (SMS). An inter-layer connection bridge (ILCB) automatically performs transformations between at least one domain specific layer (DSL) and a BPMN layer within the BMS and stores a respective link generated from each transformation in a connect layer of an ILCB layer. A semantically compatible mapping is defined between the BMS and the SMS for each of the at least one DSL, BPMN layer, ILCB layer, and connect layer. Each of the at least one DSL, BPMN layer, and ILCB layer are transformed from the BMS into a corresponding context in the SMS based on the semantically compatible mappings. The connect layer is encoded as at least one explicit bridge rule which connects the corresponding contexts within the SMS.

### BACKGROUND

The exemplary embodiment relates to modeling of business processes and finds particular application in connection with a system and method for preserving a consistent view over a set of process models in a multi-layered modeling system.

Business Process Management (BPM) addresses the methods and tools that enable the management of business processes (BPs) as they evolve throughout their lifecycles. A Business Process Management Suite (BPMS) executes business processes and connects them to various enterprise resources, such as a personnel directory, various legacy applications, and, in some cases, to the organization's Service Oriented Architecture (SOA). An enterprise SOA typically manages the reusable technical services used to execute tasks that occur in business processes.

Business processes are often modeled in abstract terms by business-oriented users who have a good business knowledge and understanding of the various roles in the organization, but who are not necessarily familiar with the details of the Information Technology (IT) services that will ultimately be used to implement the processes in the SOA. A description of a process is generated by linking together a set of high level business concepts. The concepts in which the BP is initially modeled are then described in a more structured format using a language such as Business Process Model and Notation (BPMN) to describe the business process. Once the business process descriptions are created, a BPMN editor enables users to assign roles from the organization's hierarchy to human activities, to generate forms for manual tasks, to write business rules in scripting languages to condition various execution flows as well as to connect certain tasks to SOA services, among other features.

It is often desirable for domain-specific models to be the starting point in business process design. Starting with concept definitions, process designers would create domain specific processes and eventually generate BPMN for use in BPMS solutions. To achieve this, it has been proposed that the domain-specific modeling layers be connected to the more generic BPMN layer through a connectivity layer. See, Adrian Mos, et al. “Improving Process Robustness through Domain-Specific Model Transformations,” Enterprise Distributed Object Computing Conference Workshops (EDOCW), pp 188-193 (2013). Any of the artifacts (concepts, domain processes and BPMN) in one of the layers can be modified by various stakeholders and changes in any layer may or may not influence models used in the other layers, creating incoherent views in different layers.

The preservation of a consistent view over a large number of process models in a multi-layered modeling system has been proposed. See Nikolaos Lagos, et al., “Preserving Consistency in Domain-Specific Business Processes through Semantic Representation of Artefacts,” 7th Workshop on Applications of Knowledge-Based Technologies in Business (AKTB 2015), in BIS 2015, 18th Int'l Conf. on Business Information Systems, Poznan, Poland, 24-26 Jun. (2015), hereinafter, Lagos 2015. However, this system requires that the knowledge representation (KR) formalism used is homogeneous for all generated semantic artifacts. This may be limiting in the case where it is desirable to use different KR formalisms for different artifacts and especially different layers in a distributed manner. Furthermore, this system requires a specialized user to express more complex relations between different layers.

There remains a need for a system and method which frames the business modeling space in terms of a multi-context systems theory and which solves the issues described above.

### INCORPORATION BY REFERENCE

The following references, the disclosures of which are incorporated herein by reference in their entireties, are mentioned:

U.S. Pat. No. 9,323,742, issued Apr. 26, 2016, entitled METHOD AND APPARATUS FOR PROVIDING SEMANTIC DATA ARCHITECTURE, by Jean-Yves Vion-Drury.

U.S. Pub. No. 20160162816, published Jun. 9, 2016, entitled HUMAN TASK MONITORING AND CONTEXTUAL ANALYSIS FOR DOMAIN-SPECIFIC BUSINESS PROCESSES, by Kunal Suri, et al.

U.S. Pub. No. 20150046212, published Feb. 12, 2015, entitled MONITORING OF BUSINESS PROCESSES AND SERVICES USING CONCEPT PROBES AND BUSINESS PROCESS PROBES, by Adrian C. Mos, et al.

U.S. application Ser. No. 14/691,261, filed on Apr. 20, 2015, entitled PRESERVING CONSISTENCY IN DOMAIN-SPECIFIC BUSINESS PROCESSES THROUGH SEMANTIC REPRESENTATION OF ARTIFACTS, BY Adrian C. Mos, et al.

### BRIEF DESCRIPTION

In accordance with one aspect of the exemplary embodiment, a method for semantic representation supporting multiple formalisms includes providing, in memory, a business modeling space (BMS) and a corresponding semantic modeling space (SMS). Within the BMS, data is automatically transformed between at least one domain specific layer (DSL) and a Business Process Model and Notation (BPMN) layer with an inter-layer connection bridge (ILCB). A respective link generated from each transformation is stored in a connect layer of an ILCB layer. A semantically compatible mapping is defined between the BMS and the SMS for each of the at least one DSL, BPMN layer, ILCB layer, and connect layer. Each of the at least one DSL, BPMN layer, and ILCB layer is transformed from the BMS into a corresponding context in the SMS based on the semantically compatible mappings. Within the SMS, the connect layer is encoded as at least one explicit bridge rule which connects the corresponding contexts of the at least one DSL, BPMN layer, and ILCB layer. At least one of the automatic transforming between the at least one DSL and the BPMN layer, transforming into the corresponding context in the SMS, and encoding the connect layer may be performed with a processor.

In accordance with another aspect of the exemplary embodiment, a system for semantic representation supporting multiple formalisms is provided. The system includes a business modeling space (BMS) and a corresponding semantic modeling space (SMS). Within the BMS are at least one domain specific layer (DSL), a Business Process Model and Notation (BPMN) layer, and an inter-layer connection bridge (ILCB) having an associated ILCB layer which automatically transforms at least one of: the at least one DSL to the BPMN layer, and the BPMN layer to the at least one DSL and stores a set of links generated from each transformation in a connect layer of the ILCB layer. A semantic representation component (a) receives a semantically compatible mapping defined between the BMS and the SMS for each of the at least one DSL, BPMN layer, ILCB layer, and connect layer, (b) transforms each of the at least one DSL, BPMN layer, and ILCB layer from the BMS into a corresponding context in the SMS based on the semantically compatible mappings; and (c) within the SMS, encodes the connect layer as at least one explicit bridge rule which connect the corresponding contexts of the at least one DSL, BPMN layer, and ILCB layer. A processor implements the semantic representation component.

In accordance with another aspect of the exemplary embodiment, a method for semantic representation supporting multiple formalisms includes transforming from a business modeling space (BMS) to a semantic modeling space (SMS). This includes mapping at least one domain specific layer (DSL) from the BMS to a corresponding context in the SMS, the corresponding context being generated in a first formalism, mapping a BPMN layer from the BMS to a corresponding context in the SMS, the corresponding context being generated in a second formalism, mapping an inter-layer connection bridge (ILCB) layer from the BMS to a corresponding context in the SMS, the corresponding context being generated in a third formalism, and mapping a connect layer generated in the BMS to a set of corresponding bridge rules in the SMS, the connect layer being generated by a transformation between the at least one DSL and the BPMN layer. The method further includes transforming each of the at least one DSL, BPMN layer, ILCB layer, and the connect layer from the BMS to the SMS based on the respective mapping, Additional knowledge is added to the SMS in each of the corresponding contexts, the additional knowledge being generated in a fourth formalism. The first, second, third, and fourth formalism can be the same or at least one of the first, second, third, and fourth formalisms can be different from another one of the at least one of the first, second, third, and fourth formalisms and wherein the transforming from the BMS to the SMS is performed with a processor.

### BRIEF DESCRIPTION OF THE DRAWINGS

FIG. 1 is a functional block diagram of a system for generating semantic representations of modeling layers generated by different modeling tools and for reporting information based on the semantic representations;

FIG. 2 is a flow chart illustrating a method for generating semantic representations of modeling layers generated by different modeling tools and for reporting information based on the semantic representations;

FIG. 3 is a functional block diagram illustrating various artifact layers;

FIG. 4 illustrates an example of developing a healthcare patient admission business process using various domain-specific concepts;

FIG. 5 illustrates a domain specific model using the domain specific concepts of FIG. 4;

FIG. 6, which is split into FIGS. 6A, 6B and 6C for ease of illustration, illustrates the execution of the process of FIG. 5 in one embodiment;

FIG. 7 illustrates a meta-data view of inferred information from an external ontology;

FIG. 8 is illustrates an example connection bridge meta-model;

FIG. 9 illustrates exemplary domain specific and inter-layer connection bridge modeling layer definitions and mappings;

FIG. 10 illustrates exemplary BPMN modeling layer definitions and mappings;

FIG. 11 illustrates exemplary domain specific and inter-layer connection bridge modeling layer knowledge mappings; and

FIG. 12 illustrates exemplary BPMN modeling layer knowledge mappings.

### DETAILED DESCRIPTION

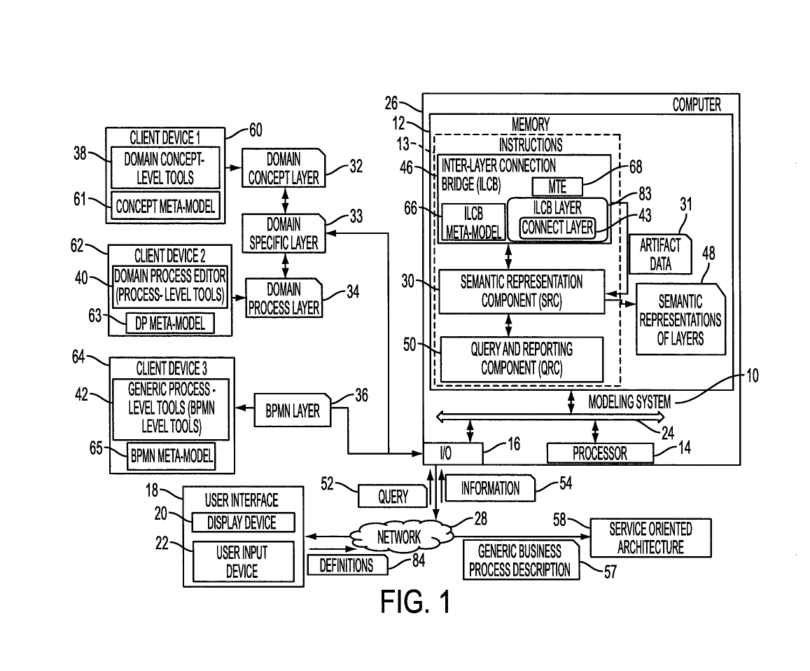

FIG. 1 illustrates a Business Process Management and Service Oriented Architecture environment which utilizes domain-specific concepts as the underpinning of BPM and SOA solutions. The architecture includes a computer-implemented system 10 for modeling business processes.

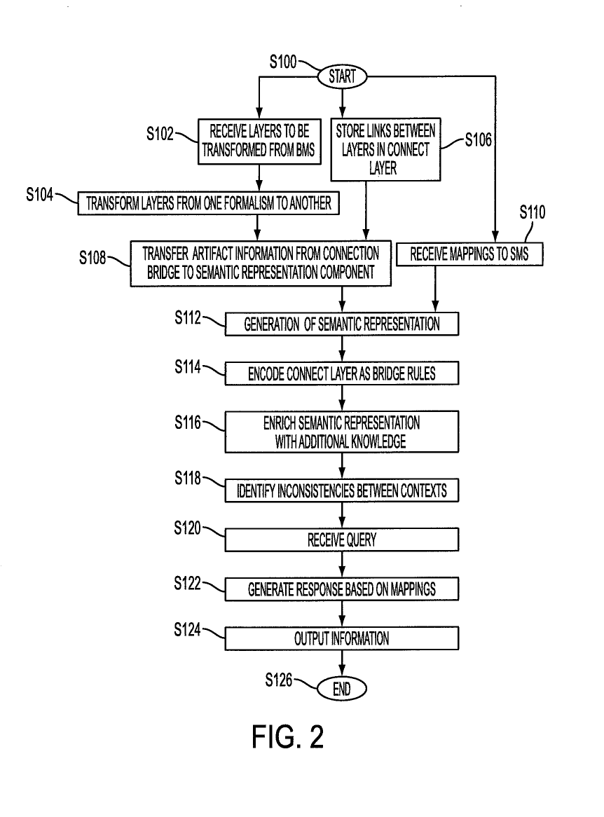

The illustrated computer system 10 includes memory 12 which stores instructions 13 for performing the method illustrated in FIG. 2 and a processor 14 in communication with the memory for executing the instructions. The system 10 also includes one or more input/output (I/O) devices, such as a network interface 16. The I/O interface 16 may communicate with one or more user interfaces 18, each with a display device 20, for displaying information to users, and a user input device 22, such as a keyboard or touch or writable screen, and/or a cursor control device, such as mouse, trackball, or the like, for inputting text and for communicating user input information and command selections to the system. The various hardware components 12, 14, 16 of the modeling system 10 may be all connected by a data/control bus 24.

The computer system 10 may include one or more computing devices 26, such as a PC, such as a desktop, a laptop, palmtop computer, portable digital assistant (PDA), server computer, cellular telephone, tablet computer, pager, combination thereof, or other computing device capable of executing instructions for performing the exemplary method.

The memory 12 may represent any type of non-transitory computer readable medium such as random access memory (RAM), read only memory (ROM), magnetic disk or tape, optical disk, flash memory, or holographic memory. In one embodiment, the memory 12 comprises a combination of random access memory and read only memory. In some embodiments, the processor 14 and memory 12 may be combined in a single chip. Memory 12 stores instructions for performing the exemplary method as well as the processed data.

The network interface 16 allows the computer to communicate with other devices via a link 28, such as computer network, e.g., a local area network (LAN) or wide area network (WAN), or the Internet, and may comprise a modulator/demodulator (MODEM) a router, a cable, and and/or Ethernet port.

The digital processor device 14 can be variously embodied, such as by a single-core processor, a dual-core processor (or more generally by a multiple-core processor), a digital processor and cooperating math coprocessor, a digital controller, or the like. The digital processor 14, in addition to executing software instructions for performing the method may also control the operation of the computer 26.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

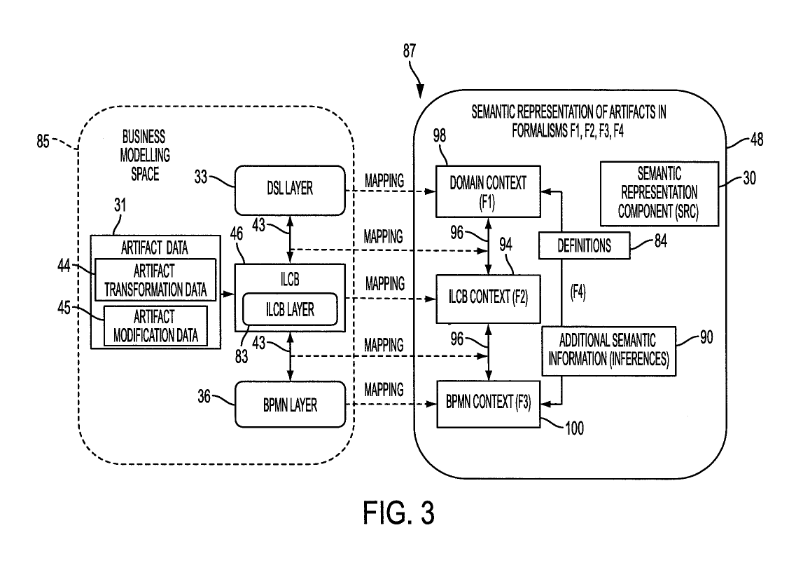

The system 10 includes a semantic representation component (SRC) 30, which receives, as input, data 31 representing artifacts or modeling layers (software components) 32, 34, 36. The layers 32, 34, 36 themselves are generated and modified by respective sets of business process tools 38, 40, 42, such as one or more domain concept level tools 38, one or more domain process level tools 40, and one or more generic process level tools 42 using respective representation formats. The artifact layers can include data such as concepts, processes, steps, transitions, and the like. As used herein, the term “formalism” refers to the formal language used to model the various layers. In this regard, the terms “formalism” and “language” may be used interchangeably. A formalism or formal language generally includes a set of strings of symbols that may be constrained by specific rules related to the domain of a layer. The domain-related language used for a domain can be domain-specific or generic, such as BPMN. The artifact layers are commonly modeled in the domain-related modeling languages employed by the respective tools. The layer artifact data 31 includes transformation data 44 and modification data 45. Some or all of the layer artifact-related data 31 may be received by the SRC 30 from an inter-layer connection bridge (ILCB) 46. The data manipulated by the ILCB is stored in an ILCB layer 83. The business process tools 38, 40, 42 and modeling layers 32, 34, 36 generated therefrom, along with the ILCB 46 and its associated ILCB layer 83, together generally define a business modeling space 85 (BMS) (FIG. 3). The BMS is considered a finite, non-empty countable set of modeling layers.

The SRC 30 outputs a semantic representation 48 of the layers 32, 34, 36, 83 and the modifications/transformations to/between them. The semantic representation 48 generally defines part of a semantic modeling space (SMS) 87, as shown in FIG. 3. A querying and reporting component (QRC) 50 receives as input a query 52 and outputs responsive information 54 that is based on the semantic representation 48.

The SRC 30 stores, in the semantic representation 48, a representation of the connections between the elements in the various layers that would otherwise be lost after transformations and modifications, allowing consistency checks and other evaluations to be performed. The SRC 30 externalizes this transformation/modification information as objects or context layers in the semantic layer 48. The semantic layer stores all the transformation traces, when they occur, and encodes them as explicit bridge rules which link the various context layers. The semantic layer also stores various mappings defined between the various modeling layers 32, 34, 36 and their corresponding context layer in the semantic representation 48. In addition, the SRC also uses inference to generate useful knowledge about process models, originally encoded in their various representation languages, from the stored transformations. Using the information in the semantic layer 48, the QRC 50 is able to respond to queries about process models 32, 34, 36, etc., at any level and return results associated to the various points of view of the various stakeholders.

The business process tools 38, 40, 42 are used to progressively develop a business process description 57 in a form which can be exported to and implemented by Information Technology (IT) services in a service oriented architecture (SOA) 58. The tools are based on meta-models, each containing various elements in a respective domain-specific language that are relevant to and correspond to graphical editing of constructs of business processes.

The illustrated domain concept-level tools 38 are used by managers to generate the domain concept layer 32, which comprises a domain-specific business process using selected ones of a set of domain-specific concepts. In the case of a healthcare patient admission process, for example, these may include selecting concepts such as “specialist consultation”, “nurse consultation,” “update medical record,” “schedule ambulance transport,” “issue prescribed medicine,” “patient registration,” and the like. In the illustrated embodiment, the domain concept tools 38 are in the form of an editor accessible to the user of a client device 60, the editor having access to or incorporating a concept level meta-model 61.

The domain process-level tools 40 are used by someone more knowledgeable about business process flows to formulate an ordered sequence from the concepts. In other words, the domain process-level tools 40 generate the domain process layer 34. In the illustrated embodiment, the domain process-level tools 40 are in the form of an editor accessible to the user of a respective client device 62, the editor having access to or incorporating a domain process (DP) level meta-model 63. The domain concept layer 32 generated by the domain concept-level tools 38 can be considered together with the domain process layer 34 as a domain-specific layer (DSL) 33.

The generic process level tools 42 are used to generate and manipulate artifacts, such as business processes, in a generic business planning notation, such as BPMN. In other words, generic process level tools 42 generate the BPMN layer 36. In the illustrated embodiment, the generic process level tools 42 are in the form of an editor accessible to the user of a respective client device 64, the editor having access to or incorporating a generic process (GP) level meta-model 65.

The Unified Modeling Language (UML) may be used for specifying and constructing the business artifacts (domain-specific concepts, domain processes, and BPMN processes) used in the various layers 32, 34, 36, while a plurality of formalisms may be used for generating the semantic representation 48, such as the Web Ontology Language (OWL) or an Answer-Set programming formalism.

User interfaces 18 and client devices 60, 62, 64 may each include memory, a processor, and one or more input/output devices, as for computer 26, in addition to a display device 20 and user input device 22. As will be appreciated the tools 38, 40, 42 may be hosted by different computing devices, as shown, or otherwise made accessible to the people who make use of these tools. In some embodiments, one of the client devices 60, 62, 64 may serve as the interface 18.

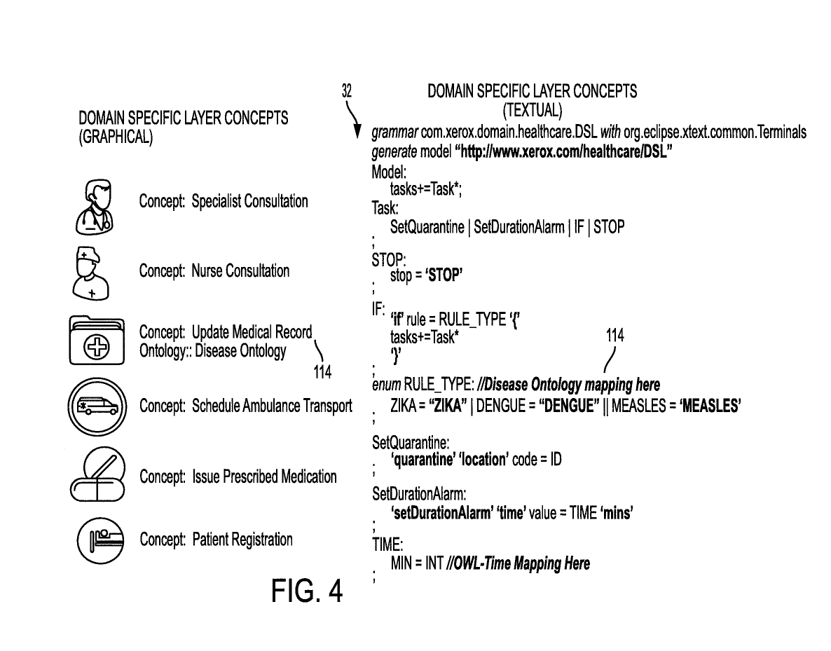

FIGS. 4-7 illustrate an example of developing a healthcare patient admission process in platform-independent form, such as BPMN, which may be generated using the business process tools. A problem with the multilayered modeling approach illustrated in FIGS. 4-7 is that any of the artifact layers (e.g., concepts 32 and domain process 34 comprising the DSL 33 and BPMN process 36) can be modified by various stakeholders. For example, when a business process needs to be improved, domain experts may enact changes using the domain process editor 40. If a BPMN process needs to be updated for BPMS specific reasons or in order to improve performance, such changes can be done by a BPMN expert in the BPMN editor 42. Changes to business concepts, for example related to SOA connectivity (how a business concept is related to services in the enterprise architecture) can be done by architects and domain experts with the concept editors 38. Such changes in one layer may sometimes influence models used in the other layers. Whether or not the changes propagate to other layers (and how much) is determined by the transformation semantics between layers. Automatic transformations are performed by the inter-layer connection bridge 46 to generate one layer from another.

The inter-layer connection bridge 46 may be used to automatically transform the layers 32, 34, 36 generated by tools at one level into layers used at another level. For example, the connection bridge 46 may take as input a domain business process 34 from client device 62 and convert it to a generic business process 36 in BPMN, which is output to client device 64. The connection bridge 46 may be configured, for example, as described in Adrian Mos, et al. “Improving Process Robustness through Domain-Specific Model Transformations,” Enterprise Distributed Object Computing Conference Workshops (EDOCW), pp. 188-193 (2013), hereinafter, Mos 2013. The transformation of artifacts from one level to another may be achieved using a core, centralized connection bridge meta-model 66 which represents the artifact layers 32, 34, 36 in a common modeling language, and a model transformation engine 68, which transforms the different artifact layers into the common format and vice-versa, as described in Mos 2013. However the connection bridge of Mos 2013 makes no provision for preserving the sources of transformation, i.e., after a transformation is performed by the model transformation engine 68, the system 10 does not retain the connection between the source of the transformation and the target. Additionally, it is very difficult to determine the implications of changes in one layer with respect to other layers.

To keep track of the transformations made by the connection bridge between DSLs and the modifications to the layers with the respective editors 38, 40, 42, the SRC receives transformation data 44 and modification data 45. Transformation data 44 represents a transformation of a layer from a source level (layer) to a target level (layer), i.e., a transformation from a source domain language to a target domain language. Modification data 45 represents the modification of one of the transformed layers in only one of the source and target layers, i.e., within one domain language. The modifications may be source modifications or target modifications. Source modifications are each a user modification to an existing layer 32, 34 in the source domain language (after a transformation has been performed). Target modifications are each a user modification to an existing layer 34, 36 in the target domain language (after a transformation has been performed).

FIG. 2 illustrates a method which may be performed with the system of FIG. 1. The method begins at S100.

At S102, within a provided business modeling space (BMS), layers to be transformed from a source domain specific language to a target domain specific language are received by the system from one of the business process editors 38, 40, 42. In particular, at least one domain-specific layer (DSL) 33 (which comprises domain concept layer 32 and domain process layer 34) and a BPMN layer 36 are received to be transformed from their respective domain language or formalism into the other's formalism.

At S104, the formalism of one of the received layers is transformed (by the transformation engine 68 of the inter-layer connection bridge 46 (ILCB)) into the formalism of the other received layer. In other words, the ILCB 46 automatically transforms artifact layers, as between the at least one DSL 33 and the BPMN layer 36.

At S106, when transformations and modifications occur in one of the layers, a link is generated which connects the layers. Each link is considered as an element of an additional layer of the BMS, referred to as a connect layer 43 stored in a layer 83 of the ILCB.

At S108, layer artifact data 31 representing the layers 33, 36, 83 and the transformations/modifications to and between them generated at S104 and S106, are output by the ILCB 46 and received by the SRC 30 in a provided semantic modeling space (SMS).

At S110, a semantically compatible mapping between the BMS and the SMS for each of the layers 33, 36, 83 and the connect layer 43 stored in S106 are defined and received by the SRC 30.

At S112, a semantic representation 48 is generated in the semantic modeling space 87, by the SRC 30, as illustrated in FIG. 3. The semantic representation 48 is generated by using layer artifact data 31 to transform each of the layers 33, 36, 83 from the BMS 85, into a corresponding context 98, 94, 100 in the SMS 87 based on the semantically compatible mappings received in S110.

At S114, within the SMS 87, the connect layer 43 is encoded as a corresponding set of explicit bridge rules 96. The bridge rules 96 connect the corresponding contexts 98, 94, 100 of the layers 33, 36, 83 to provide a set of relations and information flow between the contexts.

At S116, the semantic representation 48 in the SMS 87 is enriched with additional knowledge. Enrichment can be achieved, for example, by manipulating the SMS through the addition of additional bridge rules in each of the corresponding contexts, or through manually adding additional knowledge bases.

At S118, inconsistencies between contexts 98, 94, 100 can be identified based on additional bridge rules added in S116.

At S120, a query is received from a user and at S122, responsive information 54 is generated. The information is generated by the QRC 50, based on the semantically compatible mappings, e.g., includes information identifying inconsistencies from S118, or other information which is derived from the semantically compatible mappings. Such information may be based on inferences associated with an external ontology. At S124, the information may be output by the system. The method ends at S126.

The method illustrated in FIG. 2 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 26, (for example, an internal hard drive of RAM), or may be separate (for example, an external hard drive operatively connected with the computer 26), or may be separate and accessed via a digital data network such as a local area network (LAN) or the Internet (for example, as a redundant array of inexpensive of independent disks (RAID) or other network server storage that is indirectly accessed by the computer 26, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 2, can be used to implement the method. As will be appreciated, while the steps of the method may all be computer implemented, in some embodiments one or more of the steps may be at least partially performed manually. As will also be appreciated, the steps of the method need not all proceed in the order illustrated and fewer, more, or different steps may be performed.

The following sections describe the structure and functionality of the inter-layer connection bridge (ILCB) 46, SRC 30, and associated QRC 50 in more detail.

### Inter-Layer Connection Bridge 46

The ILCB meta-model 66 is a central, simplified representation of the main generic concepts common to business process descriptions, such as activity, flow, gateway, and the like in which business processes generated or edited with different editors 38, 40, 42 can be represented in a common representation form. FIG. 4 provides an example of such a meta-model 66 (a simplified model of an actual model of the information collected by the ILCB).

The meta-model 66 may be significantly simpler than the fully-fledged BPMN because its objective is simply to extract the essence of the structure of various business processes, and not to offer a complete modeling language. Converting between an instance of the common meta-model 66 and the domain-specific meta-models 61, 63, 65 is performed using model-based transformations. The transformations are written at meta-model level and their execution is performed at model instance level. The transformations from domain-specific meta-models to the common meta-model may be triggered by modules (not shown) that are connected to the editors 38, 40, 42. These modules may be plug-ins that integrate into the editors transparently or may be integral with the editors themselves. The modules may communicate with the model transformation engine (MTE) 68, which is responsible for executing the transformations. Once transformed into an instance of the common meta-model 66, the processes and other artifacts can be converted to another domain-related language, such as the generic language (e.g., BPMN). The conversions between the generic language and the simplified common language may be performed using meta-model operations.

### Semantic Representation Component

The SRC 30 preserves a consistent representation of all the modeling layers as well as their inter-relations in the semantic representation 48 of the semantic modeling space 87 (SMS). The primary source of information for the SRC 30 is the inter-layer connection bridge (ILCB) 46, which sends relevant data 44, 45 each time a new transformation or modification occurs. Upon receiving such data, the SRC 30 checks the consistency of the data and infers new facts.

Generation of Semantic Representation from Business Modeling Space (BMS) to Semantic Modeling Space (SMS)

FIG. 3 illustrates the relationships between the various modeling layers 33, 36, 38 which comprise the instances of the respective meta-models. The layers that constitute the backbone of the SRC system 30 can be generated as follows:

1. A direct mapping of information is extracted from the modeling layers 33, 36, 38 in the business modeling space (BMS) 85 and used to generate at least part of a semantic representation 48 in the semantic modeling space 87.

2. A direct mapping of information is extracted from each code or link 43 that exists when a transformation is carried out between the various modeling layers (e.g., from the DSL 33 or the BPMN layer 36 to the ILCB layer 83). The mappings are used to automatically generate bridge rules 96 which form at least part of the semantic representation 48.

3. A semantic representation of the different modeling layers 33, 36, 38 is generated as a corresponding object or context layer 94, 98, 100 and a corresponding mechanism to manipulate the objects in the SRC space can be applied to it. The context layers 94, 98, 100 can each be generated in formalisms (F1), (F2), and (F3), respectively.

4. User-defined definitions 84 appropriate to the business and additional semantic information 90 that aids in inferring new facts based on the definitions are added to the semantic representation 48. This additional information can be added to each context layer in a respective formalism (F4).

As modeling languages, OWL2 (http://www.w3.org/TR/owl2-overview/) SWRL (http://www.w3.org/Submission/SWRL/), and Answer-Set programming introduced by Eiter, M. Fink, and P. Schüller, “Approximations for Explanations of Inconsistency in Partially Known Multi-Context Systems,” Proc. 11th Int'l Conf. on Logic Programming and Nonmonotonic Reasoning (LPNMR 2011), vol. 6645, pp. 107-119, 2011, hereinafter Answer-Set programming, may be used for any one of formalisms (F1), (F2), (F3), and (F4), with the corresponding terminology. However, other formalisms could also be used as long as they allow the operations described below to be performed. According to some aspects of the exemplary embodiment, formalisms (F1), (F2), (F3), and (F4) can all be the same. Furthermore, many different formalisms may be used (e.g., at least one of the formalisms (F1), (F2), (F3), and (F4) can be different from another one of the formalisms (F1), (F2), (F3), and (F4)). This may be the case, for example, if different modeling layers are generated by different users in different organization units that may have access to different formalisms. As another example, different formalisms may be used to allow for optimization of diverse operations, since different formalisms are more or less appropriate according to the task at hand.

Business Modeling Space (BMS)

The business modeling space (BMS) 85 is considered as a finite non-empty countable set of modelling layers, which includes at least one domain specific layer (DSL) 33, an inter-layer connection bridge (ILCB) 46 and associated ILCB layer 83, and one generic process level tools layer 36 which may expressed in BPMN. In addition, the encoded set of connections (connect) 43 between the above layers is considered as an additional layer in the BMS.

Formally, the BMS can be denoted as the set:
BMS={DSL, ilcb, bpmn, connect}
where DSL comprises the set of domain-specific layers, which may include DSL 33, used in the BMS,
ilcb is the inter-layer connection bridge layer (e.g., ILCB layer 83),
bpmn is the generic process level tools layer (e.g., layer 36 expressed in BPMN),
connect is the encoded set of connections between the various layers (e.g., connect layer 43 linking the DSL 33, the ILCB layer 83, and BPMN layer 36),
DSL=>0, where dslᵢ is a particular domain-specific layer i in the set of domain-specific layers DSL.

The exemplary embodiment permits more than one domain specific modeling language. This advantage can be very useful in cases where concepts from one domain are re-used in the modeling of other domains. For example, when modeling the transportation of equipment, health hazardous activities happening during the transportation can be modelled using a healthcare domain specific model. In such a case, two DSLs may exist with a mapping defined between them.

Each layer in the BMS 85 can be denoted as a layer λ, expressed as a 4-tuple:

λ=<id_{λ}, Γ_{λ}, K_{λ}, A_{λ}>

where:
id_{λ} is a unique identifier for the layer (unique in the BMS),
Γ_{λ} is the language or formalism of the layer, which can be any artificial formalism suitable for modeling the appropriate information, knowledge, or system of the layer. The formalism used is commonly the same domain-related modeling language employed by the respective tool which generated the layer. The formalism can be domain-specific or generic and can be graphical and/or textual. An exemplary graphical modeling language is Business Process Modeling Notation (BPMN), which can be used to express the generic process level tools layer 36.
K_{λ} is a non-empty set of expressions written using Γ_{λ} that represents the knowledge of the layer. It is assumed that K_{λ} is well-formed, and
A_{λ} is a set of assumptions by the modeler(s) related to this layer (the set can be empty if it is assumed that the assumptions are formally expressed as a set of well-formed expressions written in Γ_{λ}).

The SRC 30 receives each layer 33, 36, 38, 43 having the form A, as described above, as part of the artifact data 31 in S108.

Semantic Modeling Space (SMS)

The semantic modeling space (SMS) 87, managed by the SRC 30, includes a finite non-empty countable set of layers or contexts 94, 98, 100. Each context 94, 98, 100 is partially the result of a transformation procedure (S112) mapping each layer 33, 36, 43 of the form λ ∈ {DSL, ilcb, bpmn} in the BMS 85 to the at least one context in the SMS. To achieve this, the multi-context systems (MCS) theory described in Gerhard Brewka, et al. “Managed multi-context systems,” Proc. Intl Joint Conf. on Artificial Intelligence (IJCAI 2011), 786-791 (2011), and Gerhard Brewka et al., “Equilibria in “Heterogeneous nonmonotonic multi-context systems,” Proc. 22nd Nat'l Conf. on Artificial Intelligence (AAAI'07), Vol. 1, pp. 385-390 (2007), hereinafter Brewka and Eiter, can be adapted to view the SMS as an MCS. Each layer 94, 98, 100 is viewed as one context of that system. Accordingly, the SMS 87 is defined as a set of n contexts by the expression:

SMS={ctx₁, ctx₂, . . . , ctxₙ},

and each context is defined as a 4-tuple:

ctxᵢ=<id_{ctx}_{ᵢ}, L_{ctx}_{ᵢ}, kb_{ctx}_{ᵢ}, br_{ctx}_{ᵢ}>,

where
id_{ctx}_{ᵢ} is a unique identifier for context ctxᵢ (unique in the SMS), and
L_{ctx}_{ᵢ} is the formal logic of the context,
kb_{ctx}_{ᵢ} is the knowledge base of the context,
br_{ctx}_{ᵢ}. is a set of bridge rules 96 generated at S114 that are used to link contexts 94, 98, 100,

The method of Brewka and Eiter is used to define L_{ctx}_{ᵢ} as a 3-tuple:

$$〈 {KB}_{{L}_{{ctx}_{i}}} , {BS}_{{L}_{{ctx}_{i}}} , {ACC}_{{L}_{{ctx}_{i}}} 〉 over a signature {\sum }_{{L}_{{ctx}_{i}}} ,$$

where

$${KB}_{{L}_{{ctx}_{i}}}$$

is the set of well-formed admissible knowledge bases of L_{ctx}_{ᵢ}, where a knowledge base is the underlying set of facts, assumptions, formulas, and rules that characterize the syntax of the logic L_{ctx}_{ᵢ}. It should be noted that kb_{ctx} ∈ KB_{L}_{_{ctx}},

$${BS}_{{L}_{{ctx}_{i}}}$$

is the set of possible belief sets, that is, sets of syntactical elements representing the beliefs a user may adopt, and a function describing the semantics of the logic L_{ctx} can have the form:

$${ACC}_{{L}_{ctx}} \text{:} {KB}_{{L}_{ctx}} \to {2}^{{BS}_{{L}_{ctx}}} ,$$

which characterizes the acceptable belief sets that may be adopted based on the knowledge represented in the knowledge base. The function ACC_{L}_{_{ctx}} assigns each element (kb_{ctx}_{ᵢ}) of KB_{L}_{_{ctx}} a set of acceptable sets of beliefs taken from BS_{L}_{_{ctx}}.

kb_{ctx} is the knowledge base of the context such that kb_{ctx} ∈ KB_{L}_{_{ctx}},

br_{ctx} is a set of bridge rules 96 generated at S114 that are used to link contexts 94, 98, 100.

The rules can be of the form:

(k:s)←(r₁:p₁), . . . , (rⱼ:pⱼ), not(rⱼ₊₁:pⱼ₊₁), . . . , not(rₘ:pₘ), in which the body of the rule (i.e., the expression to the right of the arrow) defines what should be believed or disbelieved in other contexts for the information denoted at the head of the rule (i.e., the expression to the left of the arrow) to be added to the target context, in this case k, where:

1≦rᵢ≦n (where n is the number of contexts),

pᵢ is an element of some belief set of L_{ctx}_{ᵢ}, and

k refers to the context receiving formula s, so 1≦k≦n,

(r₁:p₁) denotes that pⱼ₊₁ should be believed in context rⱼ₊₁, and

not(rⱼ₊₁:pⱼ₊₁) denotes that pⱼ₊₁ should be disbelieved in context rⱼ₊₁.

The definitions for the SMS 87 described above permit each layer 33, 36, 43 in the BMS 85 to be viewed as a knowledge source. Accordingly, the SMS 87 can be treated as a set of heterogeneous knowledge sources (i.e., context layers 94, 98, 100), in terms of supported formalisms (languages), that are inter-linked by bridge rules 96. The representation of each link or bridge rule 96 is rich enough to describe the flow of information between different sources. In other words, the contexts 94, 98, 100 themselves are considered heterogeneous in the sense that they can use different formalisms, and no notion of global consistency is required. Rather than modifying the diverse formalisms of the contexts, the necessary information flow among contexts is modeled using the bridge rules 96. As a result, the SMS 87 can represent a multi-context system where each context 94, 98, 100 can be expressed in different formalisms. For example, corresponding context 98 of the DSL 33 can be expressed in a first formalism (F1), the corresponding context 94 of the ILCB layer 83 can be expressed in a second formalism (F2), and the corresponding context 100 of the BPMN layer 100 can be expressed in a third formalism (F3). In addition, the bridge rules 96 refer in their bodies to other contexts and can thus add additional knowledge or information to a context based on what is believed or disbelieved in other contexts. This additional information can be expressed in a fourth formalism (F4).

Transformation Method

When transforming the various layers 33, 36, 43 of the BMS 85 to the SMS 87, the semantics of the original knowledge included in the BMS can be augmented, removed, or left unchanged, according to the defined mappings. To achieve this, the use of semantically-compatible mappings is required.

Semantically-compatible mapping: A mapping M is semantically-compatible iff (if and only if) there exists a mapping M̅ such that:

M ∘ M̅ ⊂ I_{K}_{_{λ}},

where M̅ is the inverse of M, I_{K}_{_{λ}} is the interpretation of the set of expressions encoded in layer λ, and ∘ denotes that the mapping M is composed with the inverse mapping M̅.

A reversible or semantics-preserving mapping is then defined as a special case of a semantically-compatible mapping as follows.

Reversible or Semantics-preserving mapping: A mapping M_{SEM} is reversible or semantics-preserving iff there exists a mapping M̅_{SEM} such that:

M_{SEM} ∘ M̅_{SEM}=I_{K}_{_{λ}}.

Part of the transformation method includes defining a number of semantically-compatible mappings between the BMS 85 and the SMS 87. The following mappings are defined.

Id mapping: A function having the expression:

i:id_{λ}→id_{ctx}., which means that there is a transformation function such that a layer (λ) identifier is transformed into exactly one context (ctx) identifier.

For example, this function could be based on a hash function linking a unique identifier of one of the layers 33, 36, 43 to a unique identifier for a corresponding context 94, 98, 100.

Knowledge mapping: a partial mapping M is defined between K_{λ} and KB_{L}_{_{ctx}} such that:

$${K}_{λ} {->}^{M} {KB}_{{L}_{ctx}} , /$$

wnicn means that there is a transformation function that, based on the partial mapping M, transforms part of the knowledge of layer λ into a set of knowledge bases of the logic L_{ctx}.

Both K_{λ} and KB_{L}_{_{ctx}} should be well-formed.

Layer-specific knowledge mapping: It follows from the above that

$${K}_{λ} {->}^{{M}_{λ}} {Kb}_{{L}_{ctx}} , /$$

which means that there is a transformation function that, based on the partial mapping M_{λ}, transforms part of the knowledge of layer λ into the knowledge base of context ctx, which is part of the set of knowledge bases expressed in the logic L_{ctx}.

such that M_{λ} ∈ M.

Connections-specific knowledge mapping: A partial mapping M_{conn} is defined between K_{connect} and br_{ctx}, where

$${K}_{connect} {->}^{{M}_{conn}} {br}_{ctx} /$$

(i.e., which means that there is a transformation function that, based on the partial mapping M_{conn}, transforms part of the knowledge of layer connect into a set of bridge rules of context ctx) so that br_{ctx} is well-formed.

The above mappings preserve well-formedness, meaning that they guarantee syntactic validity according to rules defined in the corresponding specification of the formalism during the transformation in S112. Once the transformation is done, based on the above mappings, it is assumed that extra work can be performed (S116-S122) in the SMS 87 to ensure that additional semantic coherence is achieved, up to the point that a non-conflicting state is reached (e.g. according to the MCS theory, an equilibrium state is reached). For example, bridge rules 96 can be used to achieve the additional semantic coherence.

Layer Specific Transformations

Existing methods and systems have required that all the entities in a semantic space desired to be checked for consistency have to be expressed in a global context. However, as by definition, only the entities that belong to the ILCB modeling layer can have representations in all three business modeling layers (as the ILCB layer functions as the connection between the DSL and BPMN layers). As such, the initial mapping between the ILCB layer and the corresponding semantic representation is considered the most important mapping, taking into account that the flow of information is only from the BMS to the SMS.

In the exemplary embodiment, significant changes can happen to all layers independently. This advantageously offers much more flexibility to the modeler; however it requires defining the mapping(s) of each layer in the BMS to a corresponding context in the SMS. In the case of the system shown in FIG. 1, for example, each layer 33, 36, 83 in the BMS 85 is transformed into a corresponding context 94, 98, 100 in the SMS 87 by a separate mapping. In addition, direct mappings are automatically generated from the connect layer 43 that exists from the transformations carried out between the various modeling layers in the BMS 85. The connect layer 43 is encoded in the SMS 87 in the form of bridge rules 96, which connect the corresponding contexts 94, 98, 100 with a set of relations and information flow rules. The semantic representation dataset 48 is then an aggregation of the information that is in all corresponding contexts 94, 98, 100, plus the interconnecting bridge rules 96. The mappings from each layer in the BMS 85 to a corresponding context in the SMS 87 are further discussed below.

ILCB Layer 83 to Context(s) 94

The data manipulated in the ILCB layer 83 is modelled based on the ILCB meta-model 66. It is to be appreciated that the ILCB meta-model 66 illustrated in FIG. 4 is only an example of what can be used as the basis of the ILCB layer 83 of the connection bridge 46. As an example, a version of such a meta-model from the Eclipse Mangrove project (http://www.eclipse.org/mangrove/) can be used. The model 66 includes a set of data objects 102, 104, etc., represented by boxes, such as processes, steps, transitions (what happens for going from one step to the next) with conditions (e.g., if . . . , then . . . ). Arrows 106 between the boxes represent directed associations, e.g., a set of steps are combined to form a process, which in combination may form a collection of processes. Each data object includes attributes, such as a name, a state, a description, and various modeler-definable properties. The ILCB meta-model 66 is transformed into the semantic representation 48 in the semantic modeling space 87 in step S112. In particular, the ILCB meta-model 66 is transformed based on the corresponding layer-specific knowledge mapping for the ILCB layer 83.

As an example, if the ILCB layer 83 is modeled in the Unified Modeling Language (UML) and the formalism (F2) used in the corresponding context 94 is OWL2, the mapping presented in Lagos 2015 could be used. Alternatively, the stricter mapping described by Z. Xu, et al., “Automatic extraction of OWL ontologies from UML class diagrams: a semantics-preserving approach,” World Wide Web, vol. 15, no. 5-6, pp. 517-545, September 2012, hereinafter, Xu 2012, could be used. Based on the mapping presented Xu 2012, there is a mapping M_{SEM} from the ILCB layer 83 to a corresponding ILCB context 94 such that:

$$( C , AS , R , O ) {->}^{{M}_{SEM}} ( C , P , I ) , /$$

where C is the set of UML classes,

AS is the set of UML associations,

R is the set of UML roles,

O is the set objects (instances),

C is a set of OWL2 classes,

P is a set of OWL2 object properties, and

I is a set of individuals.

The mapping, M can be defined as follows:

UML classes are represented as OWL2 classes, which is a subset of the classes in a corresponding context represented by the expression:

$$C {->}^{{M}_{SEM}} {C}_{C} ⊆ C /$$

UML associations are represented as OWL2 classes, which is a subset of the classes in a corresponding context denoted in the following expression:

$$AS {->}^{{M}_{SEM}} {C}_{AS} ⊆ C /$$

UML roles are represented as OWL2 object properties as shown in the expression:

$$R {->}^{{M}_{SEM}} P /$$

The set of tuples where the first element is a UML association, the second element is a UML role, and the third element is a UML class, are represented in the semantic space 87 as an OWL2 class that belongs to the set of classes representing UML associations, as an OWL2 object property, and as a class that belongs to the set of classes representing UML classes, respectively. The following expressions are representative:

$$∀ as ∈ AS , r ∈ R , c ∈ C , {c}_{AS} ∈ {C}_{AS} , p ∈ P , {c}_{C} ∈ {C}_{C}$$

$$\{ as \text{:} r \text{:} c \} {->}^{{M}_{SEM}} \{ {C}_{AS} \text{:} p \text{:} {c}_{C} \} /$$

Based on the above mapping, the ILCB layer 83 can be transformed into the semantic representation 48 shown as ILCB context layer 94. A part of the ILCB meta-model 66 mapped to OWL2 is shown below:

```
class Step -> Class(ilcb: Step)
class Transition -> Class(ilcb:Transition)
association hasTarget
    role target: Step[1]
    role targetTransitions: Transition[*]
end;
->
Class(ilcb:hasTarget),
ObjectProperty(ilcb:target domain(ilcb:hasTarget) range(ilcb:Step)),
ObjectProperty(ilcb:targetTransitions domain(ilcb:hasTarget)
range(ilcb:Transition))
association hasSource
    role source: Step[1]
    role sourceTransitions: Transition[*]
end;
->
Class(ilcb:hasSource),
ObjectProperty(ilcb:source domain(ilcb:hasSource) range(ilcb:Step)),
ObjectProperty(ilcb:sourceTransitions domain(ilcb:hasSource)
range(ilcb:Transition))
```

It should be noted that the expression iclb: denotes the namespace of the ILCB context 94.

As will be appreciated, the semantic model 48 includes only a portion of the information associated with the various layers which is useful in generating information 54.

BPMN Layer 36 to Context(s) 100

The data manipulated in the BPMN layer 36 is based on the BPMN meta-model 65. The transformation from the BPMN formalism used in the BPMN layer 36 to the formalism (F3) of the corresponding BPMN context 100 used in the SMS 87 requires an additional mapping. For example, assuming that the formalism used in a corresponding BPMN context 100 is OWL2, the mapping described in Rospocher, M., et al., “An ontology for the Business Process Modeling Notation.” Proc. 8th Int. Conf. on Formal Ontology in Information Systems (FOIS2014) vol. 267, pp. 133-146, 2014, could be used. Table 1 below is representative of such a mapping:

TABLE 1
Mapping of BPMN Layer to Corresponding BPMN Context

| BPMN Sequence Flow | Mapped to OWL2 |
|---|---|
| Graphical notation: | Class(bpmn:sequenceFlow), |
| [symbol] | ObjectProperty(bpmn:sourceRef |
| Attributes: | domain(bpmn:sequenceFlow) |
| sourceRef:FlowNode | range(bpmn:FlowNode)), |
| targetRef:FlowNode | ObjectProperty(bpmn:targetRef |
| XML textual notation (partial): | domain(bpmn:sequenceFlow) |
| <xsd:element name=“sequenceFlow” | range(bpmn:FlowNode)) |
| type=“tSequenceFlow” | |
| substitutionGroup=“flowElement”/> | |
| <xsd:complexType | |
| name=“tSequenceFlow”> | |
| ... | |
| <xsd:attribute name=“sourceRef” | |
| type=“xsd:IDREF” use=“required”/> | |
| <xsd:attribute name=“targetRef” | |
| type=“xsd:IDREF” use=“required”/> | |
| <xsd:attribute name=“isImmediate” | |
| type=“xsd:boolean” use=“optional”/> | |
| ... | |
| </xsd:complexType> | |

As shown in Table 1, all Flow and Connecting Objects are encoded as OWL2 classes, while attributes that connect a BPMN element to another BPMN element are encoded as OWL2 Object Properties.

DSL(s) 33 to Context(s) 98

The transformation from the DSL formalism used in the DSL 33 to the formalism (F1) of the corresponding Domain Context 100 used in the SMS 87 requires an additional mapping. However, it is not possible to define a generic mapping for the DSL(s) 33 as the mapping depends on the corresponding formalisms defined by the DSL. However, it is useful to note that if UML can be used to represent the formalisms defined by the DSL 33, and if the formalisms are well-formed, then the mapping of the ILCB layer 83 to the corresponding ILCB context 94 outlined above could be reused. Alternatively, the entities ported into the corresponding context 98 could be constrained into the entities manipulated within the ILCB layer 83. This approach would result in the porting of these entities from the DSL 33 to the same semantic formalism (e.g. OWL2) as the ILCB context layer 94, meaning that the domain context 98 would almost be a duplicate of the ILCB context layer. As a result, some flexibility would be lost, but independent changes could still be performed once the transformation is carried out and the entities are encoded in the semantic space.

Connect Layer 43 to Bridge Rules 96

In order to connect the different context layers 94, 98, 100 in the SMS 87, bridge rules 96 are used. The connections-specific knowledge mapping defined above permits the automatic generation of bridge rules 96 from the connect layer 43 in the BMS 85. The bridge rules 96 will minimally in terms of expressiveness, represent explicitly the link of the objects between the different modeling layers. As previously discussed, a code or link carries out a transformation between the various modeling layers (e.g., from the DSL 33 or the BPMN layer 36 to the ILCB layer 83). Usually, the link between the two objects is then lost (except for potentially implicit information used in the naming of the resource). However, in the exemplary embodiment, each link is saved as an element of the connect layer 43 (which is already encoded procedurally, such as in Java code), which is encoded as an explicit bridge rule 96 when the transformation to the SMS occurs. For instance, if context 1 or dsl is assumed to be the name of the context that corresponds to the DSL 33 (being encoded as a relational database), and context 2 or ilcb the name of the context that corresponds to the ILCB layer 83 (being encoded as an RDF-triple store), bridge rule br₁ could be used to represent that an entity in dsl is linked to an entity in ilcb. The following expression is representative:

∃a₁, a₂suchthatbr₁={(2:a₂)←(1:a₁)}

where a₁ and a₂ represent atoms that relate accordingly to the object that exists in the DSL 33 and the corresponding object generated in the ILCB layer 83.

Operationally, some code would have to be added to instantiate the bridge rules 96 every time such a generation operation happens. Furthermore, while br₁ expresses a non-symmetric inference, different/more expressive bridge rules can be used according to the formalism used and the result desired. For example, a bridge rule br₂ can be added to check if a₁ and a₂ are typed in their corresponding contexts. Accordingly, every time the generation operation is performed in the BMS 85, the corresponding rule is fired to generate an extra triple in the ilcb context 94:

a₁, a₂suchthatbr₂={2:(a₁skos:relatedMatcha₂)←(1:type(a₁, ? type1)), (2:a₂rdf:type? type2)}

The triple links two entities using the skos:relatedMatch predicate, one with the same identification (IRI in this case because the formalism is RDF) as a₁ with a₂. The use of “?” above denotes a variable which stands for all respective instances obtainable by value substitution. The property skos:relatedMatch is used to state an associative mapping link between two SKOS concepts. It is provided as a convenience, for situations where the provenance of data is known, and it is useful to be able to tell the difference between internal links within a concept scheme at a glance, as well as mapping links between concept schemes.

It should be noted that the use of bridge rules 96 renders information that is “implicit” in the BMS 85 into information that is “explicit” in the SMS 87. Furthermore, the knowledge related to the links among contexts 94, 98, 100 is encoded into an application-independent form, in a declarative manner, contrary to the BMS 85. It should be understood from the present disclosure that other types of bridge rules can be defined and added to the SMS 87. Such additional bridge rules can be much more complex to represent richer relations among entities from different contexts, as further discussed below.

Other Manually Added Knowledge

The SRC 30 is able to perform semantics-based inference that is not possible in the BMS 85. In addition to the information available from the specific layer transformations discussed above, other definitions can be inserted in each of the contexts of the SMS 87. These may be user-defined inference definitions 84 appropriate to the business. A definition may be of the form “A before B is true.” Additional semantic information 90 that aids in inferring new facts from the definitions 84 can be added to the semantic representation 48. If desired, only those users with appropriate profiles/rights would be able to add such definitions. Any new definitions would have to be inserted in each of the corresponding contexts of the SMS 87 and in the appropriate supported formalism (F4). As an example, in the case of an RDF-based triple store, the following fact could be inserted to represent the temporal ordering of two tasks:

ex: Paymentex: afterex: InvoiceProcess

which would mean that all payment operations must be done after processing invoices corresponding to the operation. The binary predicate ex: after in the above example could have more semantic properties attached to it, such as transitivity, which could be used by a reasoning engine (not shown) to infer additional information.

Furthermore, the method of the exemplary embodiment permits checking of both global and local consistency (corresponding to consistency in the whole SMS 87 or only in one of the contexts 94, 98, 100. This could be done, for example, by using any of the methods described in Brewka et al., “Finding explanations of inconsistency in multi-context systems,” Artificial Intelligence, vol. 216, pp. 233-274, November 2014, or M. Bögl, et al., “The mcs-ie System for Explaining Inconsistency in Multi-Context Systems,” in Logics in Artificial Intelligence, vol. 6341, pp. 356-359, 2010. The exemplary embodiment also allows query answering, as further described below, and in R. Barilaro, et al., “Towards Query Answering in Relational Multi-Context Systems,” in Logic Programming and Nonmonotonic Reasoning, vol. 8148, pp. 168-173, 2013.

Coupling the SRC with the Global Architecture

Two arrangements for coupling the SRC 30 with the rest of the system 10 are contemplated. In the first, a strong interaction is provided between the SRC 30 and the components 38, 40, 42 that modify the layers. In this case, the components 38, 40, 42 may be “SRC aware” and may use an API to exchange information with the SRC, so that the SRC can update its internal semantic representation 48 in a consistent way, and/or react directly to any problems potentially induced by components.

The other arrangement is to have a weak coupling, where the SRC analyses the products of layer transformations (typically data structures encoded according to dedicated formats such as XML), and extracts change descriptions or analysis reports by using dedicated algorithms. An advantage of this arrangement is that the compatibility with the editors and their plug-ins can be weaker, hence minimizing the impact on existing components.

The two approaches can be combined and/or chosen in accordance with the applicative domain relevance.

### Query and Reporting System

In an exemplary embodiment, the SRC 30 maintains a Resource Description Framework (RDF) store and an OWL representation of the semantic representation 48. This can be queried using standard querying language (e.g., SPARQL or other RDF query language) and its basic consistency can also be verified by existing reasoners. Dedicated properties (depending on the applicative models) can be elaborated and checked through specific inference mechanisms or queries.

The QRC 50 can then be used for powerful business process tools where various users can launch queries pertaining to their own domains of expertise.

For example, a user of the interface 60 sends a query 52 requesting information on inconsistencies between semantic relations involving two artifact layers. The QRC 50 queries the semantic representation 48 and identifies inconsistencies between the respective layers. Other queries can be made, such as: is the system in a consistent state?, and so forth.

The method is not limited to identifying inconsistencies between relations. It can also be used, for example, to evaluate other aspects of the semantic representation, such as whether one or more processes can be performed within a given time, such as the time taken by another process, and thereby determine, for example whether processes A and B can be performed in sequence and also performed in parallel with process C. Another use may be in determining the overall time taken by a complex process. Other uses may be in detecting loops, violations of structural information.

For example a query could be made such as how many processes occur between payment and shipping, or how long does this part of the process take.

### ILLUSTRATIVE EXAMPLES

The steps described above are now illustrated in the following examples illustrated in domain-specific language in FIGS. 4-12.

### Example 1

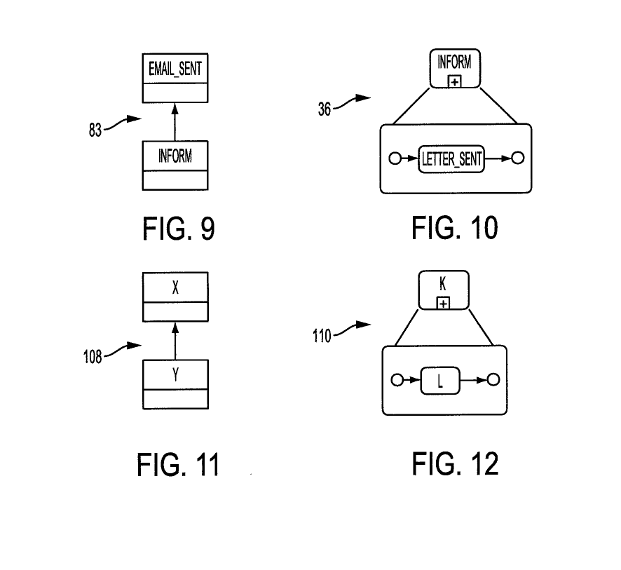

The definition shown in FIG. 9 is assumed to be defined in the ILCB layer 83 (as a result of information in the DSL) of the business modeling space. This definition expresses the fact that if a process is performed which represents the sending of an email to a third party, then the process of informing the third party is also performed. Here, the base class is Email sent and the derived class is Inform, based on UML notation. Referring to FIG. 10, the corresponding information is expressed in the BPMN layer 36. A sub-process of Inform is illustrated by the class Letter sent. The knowledge mappings 108 from the base class to the derived class or subclass can be generalized as shown in FIG. 11 and by the expression:

Y:-X,

i.e., there is a production rule whereby Y produces X, where X,Y stand for stand for variables to be instantiated. Similarly, the knowledge mappings 110 in the BPMN layer are shown in FIG. 12 and are generalized by the expression:

L:-K

The variables X,Y and K,L can be instantiated, for example, in the formalism of Answer-Set programming, and MCS-IE: Multi-Context Systems Inconsistency Explainer,” available at http://www.kr.tuwien.ac.at/research/systems/mcsie/. The operator :- denotes a production rule, the left side being the head.

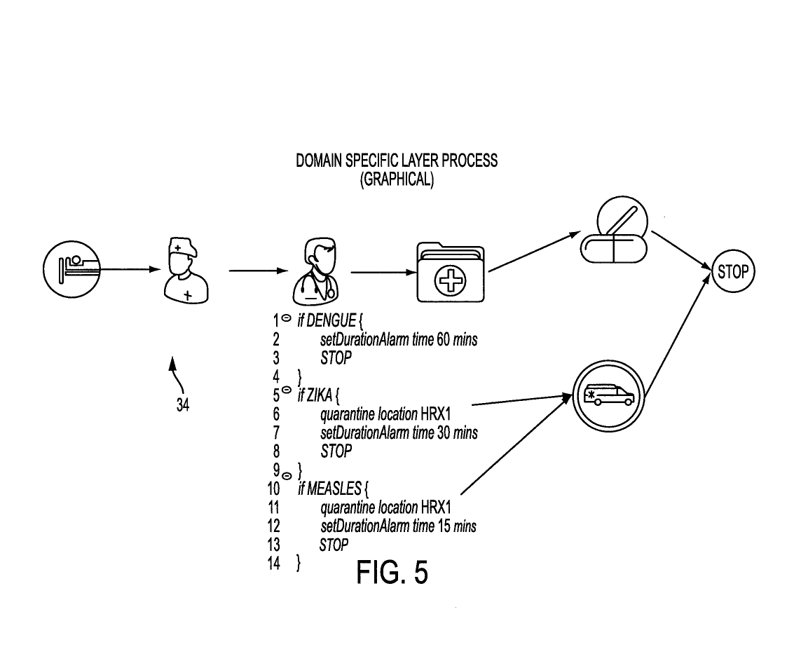

Accordingly, the layer-specific knowledge mappings defined in FIGS. 5A and 5B are instantiated in the specific formalism of Answer-Set programming introduced by Eiter and MCS-IE by the expressions:

Inform:-Email_sent

Letter_sent:-Inform

In order to link the two objects with the same naming in the two different layers, one minimal bridge rule is assumed. The bridge rule explicitly links the objects between the different modeling layers (i.e., the DSL and the BPMN layer 36) when the transformation is carried out to the ILCB layer 83. With the current local knowledge bases illustrated in FIGS. 5A and 5B, the following expression is thus generated:

(2:inform):-(1:inform)

From the mappings defined above, the following Answer-Set program is developed:

% Bridge rule between ILCB context and BPMN context

r1:(2:inform):-(1:inform).

% ILCB context (context 1)

inform:-email_sent.

% BPMN context (context 2)

letter_sent:-inform.

Once run, the Answer-Set program above gives the following additional inference that uses information from two different contexts:

(2:letter_sent):-(1:email_sent)

As discussed above, after the initial stage of transformations is performed, additional knowledge can be added directly to the SMS 87. For example, the SMS can be manipulated via the addition of bridge rules. Thus, for this particular example, a bridge rule can be added that denotes when a letter is not sent then an email should have been sent. The bridge rule takes of the following form:

% Bridge rule denoting that when a letter is not sent an email should be sent

r2:(1:email_sent):-not (2:letter_sent).

As before, this bridge rule uses information from both contexts without the need of copying information from one context to the other. The full program now has the following form, expressed in the formalism of MCS-IE:

#context(1,“d1v_asp_context_acc”, “ILCB.dlv”).

#context(2,“dlv_asp_context_acc”, “BPMN.dlv”).

% Bridge rules

r1:(2:inform):-(1:inform).

r2:(1:email_sent):-not (2:letter_sent).

===ILCB.dlv===

% ILCB context

inform:-email sent.

===BPMN.dlv===

% BPMN context

letter_sent:-inform.

Running this program on a corresponding tool (i.e., MCS-IE), gives the following result:

Dm:EQ:({ },{r2}):({inform},{letter_sent})

Dm:EQ:({r1},{ }):({inform},{ })

Em:({r1,r2},{r1,r2})

The above code indicates that after the addition of the second rule there is a conflict between the information included in the ILCB context, the BPMN context, and the corresponding bridge rules. An advantage of the exemplary embodiment is that not only are the rules that generate the conflict realized (i.e. the combination of rules 1 and 2 as denoted by Em:({r1,r2},{r1,r2})), but the result of removing or adding the rules is also realized. For instance, the line Dm:EQ:({r1},{ }):({inform},{ }) denotes that if the bridge rule r1:(2:inform):-(1:inform) is removed, then there is a valid state where {inform} is a valid knowledge base for the ILCB context (as r1:(2:inform):-(1:inform) is defined in the combination of the ILCB context, BPMN context, and the bridge rules).

### Example 2

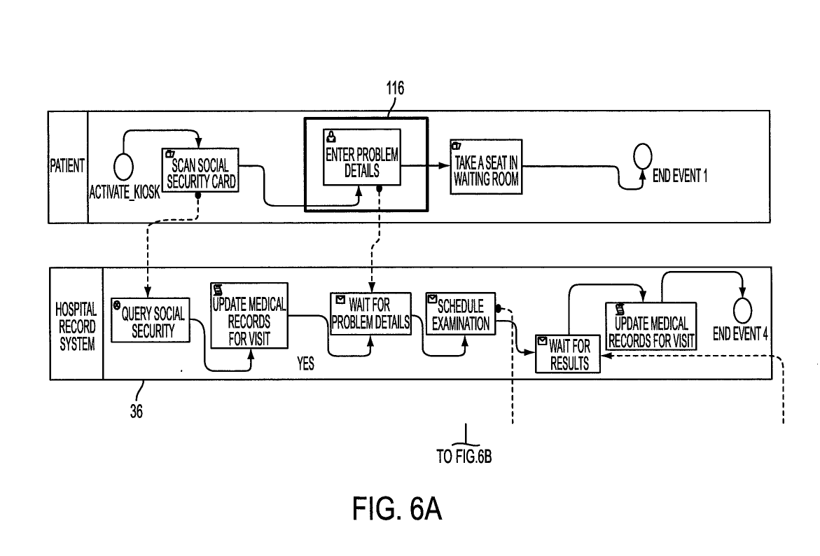

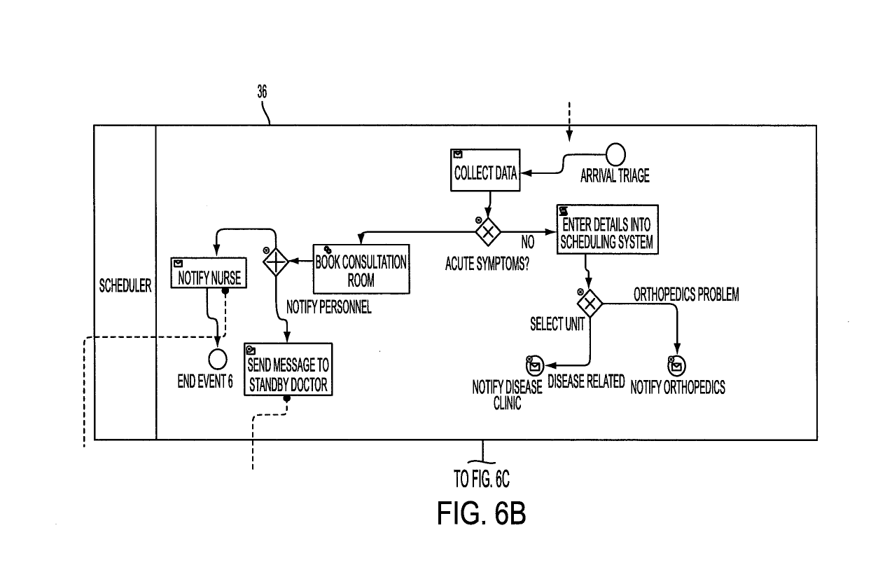

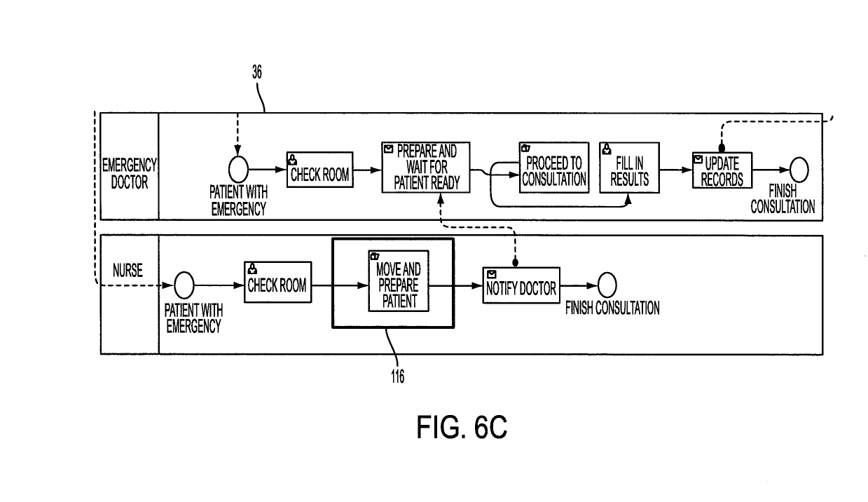

Example 2 illustrates an example healthcare patient admission process illustrated in domain-specific language in FIGS. 4-8. Example 2 in particular illustrates an advantage realized by the exemplary embodiment, that is, the need for supporting the use of different contexts and how this can be achieved with the steps described above. FIG. 4 shows domain specific concepts developed for Example 2, FIG. 5 illustrates the corresponding domain-specific process model, and FIG. 6 (which is split into FIGS. 6A, 6B and 6C for ease of illustration) details a partial view of a relevant encompassing BPMN model that could be defined by a hospital staff which utilizes the healthcare patient admission process.

In the healthcare domain specific layer (DSL) 32, once a patient arrives at a hospital counter, a number of administrative processes have to take place. This includes recording the patient's details (via connection to social security), the symptoms of the patient, and scheduling further steps, such as a more specialized examination by a medical doctor, additional examination including X-rays or a simple nurse visit. Information related to the scheduling process is also recorded and acted upon, for example, whether a specialized clinic has to be contacted and provided with recorded patient information.

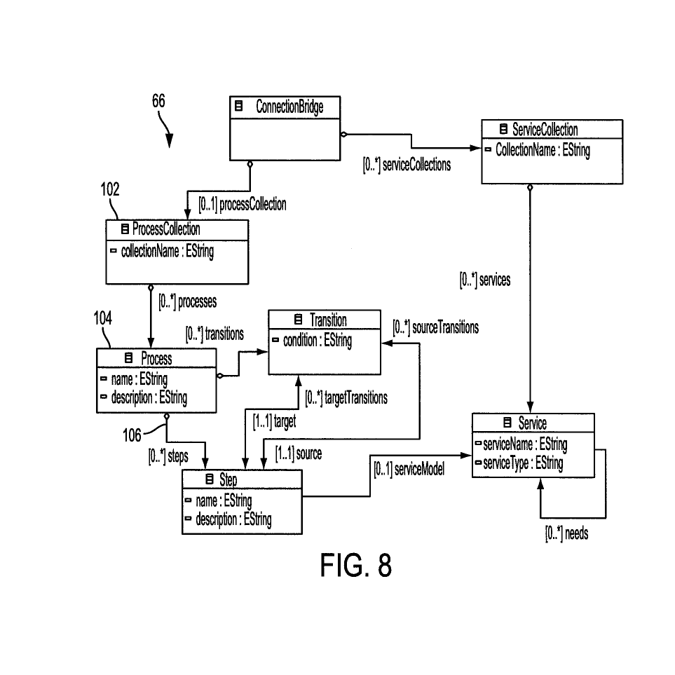

While the BPMN process 36 detailed in FIG. 6 illustrates the workflow that is followed, a number of domain-specific constraints are defined in the DSL 32. These domain-specific constraints are especially related to Service Level Agreements (SLA) or domain-specific knowledge as illustrated FIG. 8 and FIG. 6. For example, the time that a patient has to wait in the waiting room is conditioned on the seriousness of exhibited symptoms. Based on specific symptoms, additional decisions will be decided, such as whether the patient will be referred to a specialized viral infection clinic or be constrained in an isolation room, etc.

Accordingly, a typical query 52 posed by a business process designer may include: “in the case that the patient has a viral infectious disease, is the time from the moment he/she arrives to the hospital to the moment that he/she is put in an isolation room in accordance to the allowed duration specified in the SLA?” (e.g., a longer than 15-minute stay has been identified dangerous for some diseases like measles). Such information is typically described in a domain-specific model 32 like the one shown in FIG. 4.

In order to be able to reply to the above query, at least two additional questions need to be answered, including: (Question 1) “What is a viral infectious disease? (e.g., how do we know that measles is a viral infectious disease?), and (Question 2) “What does a more than 30-minute duration mean?” These questions can only be answered after mapping to the semantic modeling space 87.

To answer Question 1, that is, to find out whether measles is a viral infectious disease, corresponding ontologies 112 and relevant inferred information 90 can be used. Medical ontologies have a widespread use in the healthcare domain. One such example of a well-known medical ontology is the SNOMED CT ontology, described in F. Baader, et al., “Pushing the EL Envelope,” Proc. 19th Int'l Joint Conf. on Artificial Intelligence, October 2005, hereinafter Baader. In addition, the Disease Ontology (DO) (http://disease-ontology.org/) provides maps to terms and concepts of SNOMED CT.

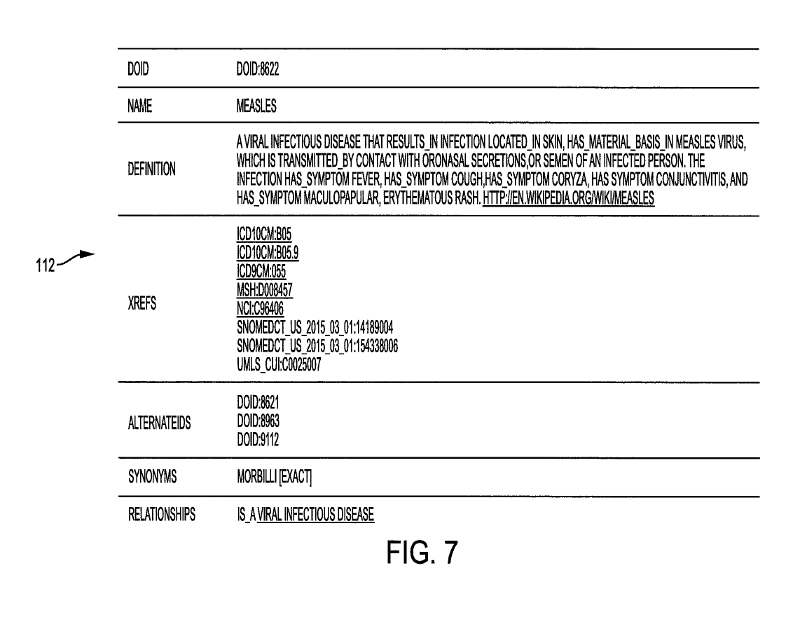

The mappings 114 to the DO are shown in FIG. 4 in two different places, the Domain Specific Layer Concepts graphical side, which in this case is a Disease Clinical Pathway, at the Update Medical Record concept, and in the Domain Specific Layer Concepts textual side, which in this case is a Disease Clinical Evaluation, at the enum RULE_TYPE field. The notion of measles in the DO, and the mapping to SNOMED CT, is shown in FIG. 7. FIG. 7 represents the meta-data view of measles in the DO, where it can be seen that measles is classified as a viral_infectious_disease and that it is mapped to two concepts in SNOMEDCT (SNOMEDCT_US_2015_03_01:14189004, and SNOMEDCT_US_2015_03_01:154338006), among other terminologies and ontologies.

External ontologies such as SNOWMED CT are useful for the definitions 84 of information, such as above where whether a disease such as measles is classified as a viral infectious disease is inferred. Because of their sheer size, most ontologies are restricted in terms of expressivity. SNOMED CT, for example, is restricted to the EL++ DL expressivity as described by Baader. The EL++ DL expressivity is one of the few description logics for which standard reasoning problems such as ontology consistency, concept subsumption, and instance checking are decidable in polynomial time. To achieve that performance, commonly-used constructors such as universal value restrictions and inverse and functional roles are not allowed in EL++ inference. For SNOMED-CT however, scalable reasoning is more important than the lost language expressivity, as discussed in B. Suntisrivaraporn, “Polynomial-Time Reasoning Support for Design and Maintenance of Large-Scale Biomedical Ontologies,” PhD thesis, TU Dresden, 2009, and Kathrin Dentler, et al., “Comparison of reasoners for large ontologies in the OWL 2 EL profile,” Semantic Web 2, 2: 71-872011 (April 2011), DOI=http://dx.doi.org/10.3233/SW-2011-0034. The EL++ DL is expressed by the OWL 2 EL profile specification at http://www.w3.org/TR/owl2-profiles/#OWL_2_EL. Corresponding specialized reasoners focus on optimizing the corresponding operations only, such as those described by J. Mendez et al., “Reintroducing CEL as an OWL 2 EL Reasoner,” Proc. 2009 Int'l Workshop on Description Logics, vol. 477, 2009, and E. Thomas, et al., “TrOWL: Tractable OWL 2 Reasoning Infrastructure,” Proc. Extended Semantic Web Conf., 2010, for example. A common service that is offered by SNOMED CT is responding to queries 52 based on its specific inference profile, as a third-party service.

In order to answer Question 2 above, it is useful to be able to perform inferences 90, such as a temporal inference. A number of specialized temporal inference engines have been described, based on first or higher order logics, which may be used herein. The most widely used ontology for representing time-related information is OWL-Time.

OWL-Time contains many commonly used notions used in temporal inference. For example, the before and after properties can be used to represent time sequences, that is, the notion that a time point or interval is after/before another time point interval. Advantageously, OWL-Time explicitly defines the semantics of a minute, in relation to intervals, durations and other temporal units (e.g., seconds or days). This permits response to a query 52 involving a comparison of temporal units in relation to a duration entity, like in Question 2 above. A number of specialized temporal inference engines/services provide corresponding computation based on the above ontology. However, OWL-Time includes a number of concepts that provide for a higher expressivity than EL++. For instance, the after property is defined as the inverse of before, which is not permitted in EL++. Further, the relation before is declared as transitive in order to infer implied relations and disjoint with after, its inverse relation, in order to detect inconsistencies. OWL specifications disallow the combination of transitivity and disjointness (or asymmetry) axioms on a property because they can lead to un-decidability, as discussed in I. Horrocks, et al., “The Even More Irresistible SROIQ,” Proc. KR 2006, 2006. This restriction is necessary in order to guarantee decidability in reasoning with OWL 2 DL, and therefore description logic reasoners generally do not allow it.

As a result, in order to be able to respond to Question 1 and Question 2, two different inference strategies can be employed e.g., by providing access to corresponding third-party tools. Such architectural and functional flexibility is supported by the framework of the exemplary embodiment. In particular, knowledge-level mappings to OWL have been defined/described above, and layer-level mappings to OWL-Time are shown in the Disease Clinic Evaluation DSL at the TIME field in FIGS. 4 and 5.

### Example 3

Referring to FIG. 6, the boxes 116 around the steps of “Enter Problem Details” and “Move and Prepare Patient” indicate that, at run-time, the business modelling expert may also want to be able to know how much time it takes from the moment “Enter Problem Details” is launched for execution to the moment the “Move and Prepare Patient” is executed. Such information can be gathered by monitoring tools, such as those described in above-mentioned U.S. Pub. Nos. 20150046212 and 20160162816 and in Mos, A., “Domain Specific Monitoring of Business Processes using Concept Probes,” Intelligent Service Clouds Workshop (ICSOC 2014). Volume: ICSOC 2014 workshops and satellite events, November 3-November 6, Paris, France (2014) and Suri, K., and Mos, A., “Human task monitoring and contextual analysis for domain specific business processes,” Int'l Conf. on Software & System Engineering (ICSSEA 15), Paris, France, 27-29 May (2015). Once this information is gathered, it can be transformed by the SRC 30 into instantiations of the OWL-Time ontology via the framework of the exemplary embodiment. After this transformation, it is possible to query the corresponding semantic model knowledge base for this information. At the same time, a common query posed in the DSL 33 is related to the number of steps or processes that took place, such as within the last day, including a specific type of information. As discussed in Example 2 above, this information could be viral infectious diseases, which would require the use of medical ontologies encoded in EL++.

As a result, it is shown that temporal inference and querying based on OWL-Time is useful for BPMN layers, as well as in domain-specific layers such as those discussed in Example 2. Furthermore, different formalisms may be required not only for contexts relating to the same business space layer, but also for two different layers, i.e. the domain-specific and BPMN layers.

The exemplary system and method find use in the systematic management of business artifact layers (e.g., domain-specific concepts, domain processes and BPMN). It does so by introducing semantically compatible mappings to transform business models into semantic models on which inferences can be performed and conflicts can be identified and potentially queried upon, on top of domain-specific concepts as well as external concepts inherent to BPMN-based tools, which intrinsically do not allow this kind of semantic representation. By defining business modelling space 85 as an aggregation of layers that hold domain-specific and BPMN related representations, in addition to the connections between those two views represented as an intermediate layer and also in terms of explicit connections between the three layers, the foundation for improved search capabilities as well as consistency checks across the organization's business processes is provided. The flexibility of this formalism enables business processes to have limited redundancy of information across layers, explanations in terms of potential solutions in the presence of conflicts, expression of richer information on the relations between two contexts via the notion of bridge rules, and to add information in any of the contexts of the system via inferences taking place in the SMS 87.

The exemplary system and method may also contribute to the advances in the field of Multi-Context systems, e.g. advanced distributed computations, probabilistic variants, as well as exploit innovations in data governance and data management.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for semantic representation supporting multiple formalisms comprising:
providing, in memory, a business modeling space (BMS) and a corresponding semantic modeling space (SMS);
within the BMS, automatically transforming data between at least one domain specific layer (DSL) and a Business Process Model and Notation (BPMN) layer with an inter-layer connection bridge (ILCB) and storing a respective link generated from each transformation in a connect layer of a layer of the ILCB;
defining a semantically compatible mapping between the BMS and the SMS for each of the at least one DSL, BPMN layer, ILCB layer, and connect layer;
transforming each of the at least one DSL, BPMN layer, and ILCB layer from the BMS into a corresponding context in the SMS based on the semantically compatible mappings; and
within the SMS, encoding the connect layer as at least one explicit bridge rule which connects the corresponding contexts of the at least one DSL, BPMN layer, and ILCB layer;
wherein at least one of the automatically transforming data between the at least one DSL and the BPMN layer, transforming into the corresponding context in the SMS, and encoding the connect layer is performed with a processor.

2. The method of claim 1, further comprising defining each one of the at least one DSL, BPMN layer, and ILCB as a tuple including a unique identifier of the layer, a language of the layer, a non-empty set of expressions written in the language of the layer and representing a knowledge of the layer, and a set of assumptions related to the layer.

3. The method of claim 1, further comprising defining each corresponding context in the SMS as a tuple including a unique identifier of the context, a formal logic of the context, a knowledge base of the context, and the set of bridge rules which connect the contexts.

4. The method of claim 1, wherein the semantically compatible mappings preserve well-formedness.

5. The method of claim 4, wherein defining the semantically compatible mappings includes partially mapping a knowledge of each layer to a knowledge base of a formal logic of the corresponding context to define a knowledge mapping.

6. The method of claim 5, further comprising partially mapping the knowledge of each of the at least one DSL, BPMN layer, and ILCB layer to a knowledge base of the corresponding context to define a layer-specific knowledge mapping.

7. The method of claim 4, wherein defining the semantically compatible mappings includes partially mapping a knowledge of the connect layer to the set of bridge rules which connect the contexts.

8. The method of claim 1, wherein the corresponding contexts in the SMS are generated in a plurality of formalisms.

9. The method of claim 8, wherein the plurality of formalisms include a web ontology language and an Answer-Set programming formalism.

10. The method of claim 1, further comprising manipulating the SMS by adding additional bridge rules.

11. The method of claim 10, further comprising providing for identifying an inconsistency between contexts, the inconsistency being based on the additional bridge rules.

12. The method of claim 1, further comprising providing for receiving a query and outputting information based on the semantically compatible mappings.

13. The method of claim 12, wherein the outputting information is based on an inference associated with an external ontology.

14. The method of claim 13, wherein the inference is a temporal inference.

15. A computer program product comprising a non-transitory recording medium storing instructions, which when executed on a computer, causes the computer to perform the method of claim 1.

16. A system comprising memory which stores instructions for performing the method of claim 1 and a processor in communication with the memory for executing the instructions.

17. A system for semantic representation supporting multiple formalisms comprising:
a business modeling space (BMS) and a corresponding semantic modeling space (SMS);
within the BMS, at least one domain specific layer (DSL), a Business Process Model and Notation (BPMN) layer, and an inter-layer connection bridge (ILCB) having an associated ILCB layer which automatically transforms data from at least one of:
the at least one DSL to the BPMN layer, and
the BPMN layer to the at least one DSL, and stores a set of links generated from each transformation in a connect layer of the ILCB layer;
a semantic representation component which:
(a) receives a semantically compatible mapping defined between the BMS and the SMS for each of the at least one DSL, BPMN layer, ILCB layer, and connect layer;
(b) transforms each of the at least one DSL, BPMN layer, and ILCB layer from the BMS into a corresponding context in the SMS based on the semantically compatible mappings;
(c) within the SMS, encodes each respective connect layer as at least one explicit bridge rule which connect the corresponding contexts of the at least one DSL, BPMN layer, and ILCB layer; and
a processor which implements the semantic representation component.

18. The system of claim 17, further comprising a querying and reporting component which receives an input query and outputs information based on the semantically compatible mappings.

19. The system of claim 17, further comprising a first business process tool which generates the at least one DSL and a second business process tool which generates the BPMN layer.

20. A method for semantic representation supporting multiple formalisms comprising:
transforming from a business modeling space (BMS) to a semantic modeling space (SMS) comprising:
mapping at least one domain specific layer (DSL) from the BMS to a corresponding context in the SMS, the corresponding context being generated in a first formalism;
mapping a BPMN layer from the BMS to a corresponding context in the SMS, the corresponding context being generated in a second formalism;
mapping an inter-layer connection bridge (ILCB) layer from the BMS to a corresponding context in the SMS, the corresponding context being generated in a third formalism;
mapping a connect layer generated in the BMS to a set of corresponding bridge rules in the SMS, the connect layer being generated by a transformation between the at least one DSL and the BPMN layer;
transforming each of the at least one DSL, BPMN layer, ILCB layer, and the connect layer from the BMS to the SMS based on the respective mapping; and
adding additional knowledge to the SMS in each of the corresponding contexts, the additional knowledge being generated in a fourth formalism,
wherein at least one of the first, second, third, and fourth formalisms is different from another one of the at least one of the first, second, third, and fourth formalisms and wherein the transforming from the BMS to the SMS is performed with a processor.
